(19) United States
(12) Patent Application Publication
(10) Pub. No.: US 2012/0112481 A1
(43) Pub. Date: May 10, 2012

(54) HANDLING ASSEMBLY FOR A WIND TURBINE BLADE

(76) Inventors: Rolf Reinfried ten Thoren, Rheine (DE); Martin Goettsch, Hamburg (DE)

(21) Appl. No.: 13/332,314

(22) Filed: Dec. 20, 2011

(51) Int. Cl. B66C 1/62; B65D 81/05; B65B 5/04

(52) U.S. Cl. 294/67.1; 53/452; 206/522

(57) ABSTRACT

A handling assembly for a wind turbine blade is provided, comprising a frame adapted to at least partially surround a section of the wind turbine blade, and an expandable cushion adapted to fill at least part of the space between the section of the wind turbine blade and the frame.

### BACKGROUND OF THE INVENTION

The subject matter described herein relates generally to devices and methods for handling wind turbine blades, for example devices and methods that aid in the handling, transportation, storage, mounting, installation, and/or packaging of wind turbine blades. Wind turbine blades vary in size and shape, often with lengths of many tens of meters. After manufacture, wind turbine blades usually require transport to an installation site. Handling assemblies are used in the transportation and installation of wind turbine blades.

### BRIEF DESCRIPTION OF THE INVENTION

According to one aspect, a handling assembly for a wind turbine blade is provided, comprising a frame adapted to at least partially surround a section of the wind turbine blade, and an expandable cushion adapted to fill at least part of the space between the section of the wind turbine blade and the frame.

According to another aspect, a handling assembly for a wind turbine blade is provided, comprising a frame adapted to at least partially surround a section of the wind turbine blade, an inflatable cushion, and a port; the frame comprises openings adapted to allow the wind turbine blade to be positioned through the frame; the inflatable cushion comprises a chamber; the port is connected to the chamber to allow at least one of an influx and an outflux of a fluid; and the influx of fluid is associated with expansion of the cushion and casting of the cushion to at least a portion of the surface of the wind turbine blade.

According to another aspect, a method of handling a wind turbine blade is provided, comprising placing a handling assembly around a portion of the wind turbine blade, and expanding an expandable cushion between the handling assembly and the wind turbine blade to hold the wind turbine blade.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine, according to embodiments described herein.

FIG. 2 is an exemplary wind turbine blade and handling assembly, according to embodiments described herein.

FIG. 3 is a cross-section of a wind turbine blade and handling assembly having a frame and an expandable cushion, according to embodiments described herein.

FIG. 4 is a cross-section of a wind turbine blade and handling assembly having a port, according to embodiments described herein.

FIG. 5 is a cross-section of a wind turbine blade and handling assembly having a movable lid, according to embodiments described herein.

FIG. 6 is a cross-section of a wind turbine blade and handling assembly having a movable lid, according to embodiments described herein.

FIG. 7 is a cross-section of a wind turbine blade and handling assembly, according to embodiments described herein.

FIG. 8 is a cross-section of a handling assembly for a wind turbine blade, according to embodiments described herein.

FIG. 9 is a cross-section of a handling assembly for a wind turbine blade, having a cushion with two chambers, according to embodiments described herein.

FIG. 10 is a cross-section of a handling assembly for a wind turbine blade, comprising internal fixations, according to embodiments described herein.

FIG. 11 is a handling assembly for a wind turbine blade, the handling assembly having two parts, according to embodiments described herein.

FIG. 12 is a handling assembly for a wind turbine blade, the handling assembly having an attachment point, according to embodiments described herein.

FIG. 13 is a handling assembly for a wind turbine blade, the handling assembly having multiple attachment points, according to embodiments described herein.

FIG. 14 is a handling assembly for a wind turbine blade, the handling assembly having a platform, according to embodiments described herein.

FIG. 15 is a cross-section of a handling assembly for a wind turbine blade, according to embodiments described herein.

FIG. 16 is a cross-section of a handling assembly for a wind turbine blade, according to embodiments described herein.

FIG. 17 is a cross-section of a handling assembly for a wind turbine blade, the handling assembly having an expandable cushion adapted to wrap at least partially around the blade, according to embodiments described herein.

FIG. 18 is a flow chart describing a method of handling a wind turbine blade, according to embodiments described herein.

FIG. 19 is a flow chart describing a method of handling a wind turbine blade, according to embodiments described herein.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a handling assembly for a wind turbine blade that provides a way to safely hold a blade, or fix the position of the blade. More specifically, according to many embodiments, a precise and determined enclosure safely fixes the blade so as to avoid damage to the blade. Alternatively or additionally, the handling assembly adapts to variable blade geometry, enabling an optimal pressure distribution over the surface of the blade, and compensating shape variations which may be due to variable blade geometry. The handling assembly helps to avoid damage to the blade during all types of handling, such as for example transportation, storage, mounting, lifting, installation, packaging, and the like.

Modern, lightweight wind turbine blades may be very sensitive to forces applied at fixing points at given locations of the profile. The blade skin may consist only of a few plies or layers with the exception of the upper and lower girder and/or the sparcap. The handling assembly helps to avoid damage to the blade during handling.

As used herein, the terms “blade,” “wind turbine blade,” and “rotor blade” are used synonymously. As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power. As used herein, the term “handling” is intended to be representative of activities such as for example transporting, preparing for storage, removing from storage, storing, mounting, lifting, installing, erecting, packaging, erecting, hoisting, and the like. Herein, holding assembly and handling assembly are used interchangeably. Herein: activation of the handling assembly is representative of action taken to hold a blade; deactivation is representative of action taken to release or loosen a blade; and preactivation is representative of action taken before activation of the handling assembly, which may be processes of preparing or enhancing the protective and/or gripping (e.g. holding) action of the cushion on the blade, frame, or both. Herein, a fluid may be a gas such as air. Herein holding, gripping, and fixing the blade are used interchangeably.

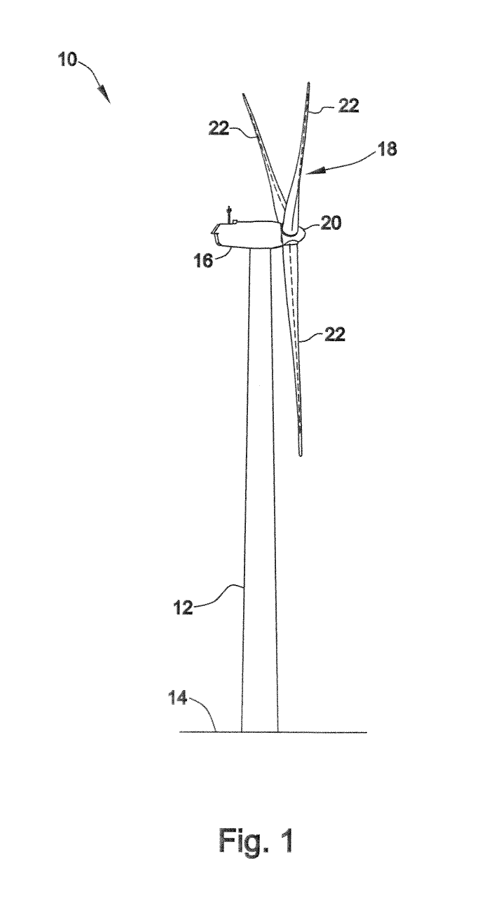

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on the tower 12, and a rotor 18 that is coupled to nacelle 16. Rotor 18 includes a rotatable hub 20 and at least one wind turbine blade (or rotor blade or blade) 22 coupled to and extending outward from hub 20

In one embodiment, rotor blades 22 have a length ranging from about 15 meters (m) to about 91 m. For example, other non-limiting examples of blade lengths include 10 m or less, 20 m, 37 m, or a length that is greater than 91 m.

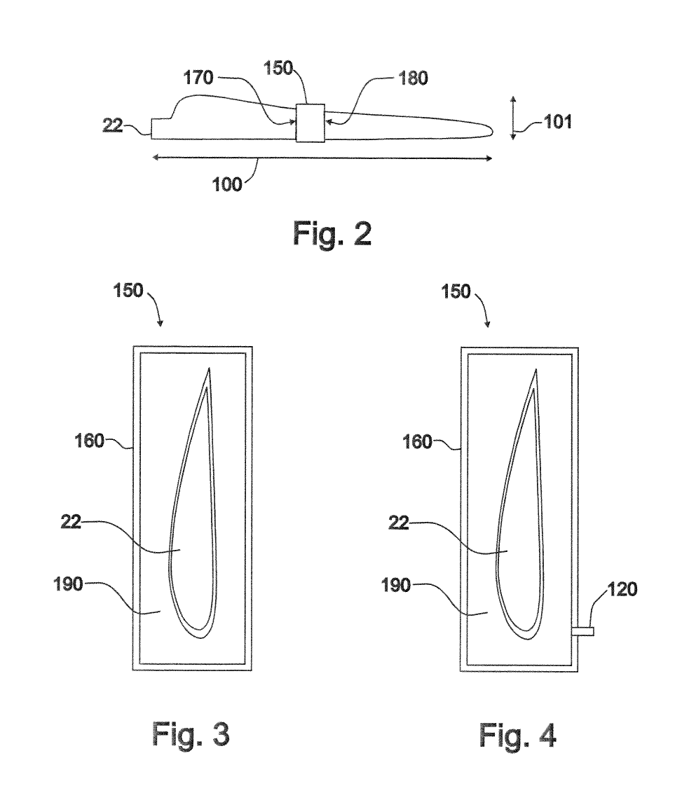

FIG. 2 shows a typical wind turbine blade 22, with a long axis 100 and a width direction, or width 101, according to an embodiment. The short axis of the blade is perpendicular to the page of the figure. The blade 22 is held by a handling assembly 150 comprising a frame with two openings 170, 180 on opposite sides of the frame. When in use in handling a blade, the openings are intersected by the long axis 100 of the blade. The two openings 170, 180 of the frame are adapted to allow the wind turbine blade to be positioned through the frame.

FIG. 3 shows a cross-section of a handling assembly 150 according to an embodiment. The handling assembly comprises a frame 160 adapted to at least partially surround a section of the blade 22, and an expandable cushion 190. The two openings of the frame are parallel with the page of FIG. 3. In an embodiment, the frame is rigid and rectangular although other shapes are possible, such as polyhedral with two opposing openings. The openings are adapted to intersect the long axis of the blade, and/or to allow the blade to be positioned through the frame. When in use in handling a blade, the frame at least partially surrounds a section of the blade.

The expandable cushion 190 is adapted to occupy at least part of the space between a section of the blade 22 that is at least partially surrounded by the frame 160 and the inside wall of the frame. In an embodiment, soft packing particles, a fluid, or a combination thereof are disposed within the expandable cushion 190. For example, soft packing particles such as polystyrene fill, polystyrene balls, polystyrene peanuts, starch-based particles, foam peanuts, or the like are used. The expandable cushion may also comprise a chamber, which may be one or more (e.g. all) of the parts of the cushion that is expandable (e.g. inflatable). The expandable cushion may also contract. The expandable cushion may be a hose or a pillow.

In an embodiment, the cushion is activated, deactivated, and preactivated by the flow of fluid. Activation is intended to be representative of preparing to handle the blade, wherein the blade is to be held in the handling assembly. An activated handling assembly is intended to be representative of a handling assembly that is holding a blade, preferably robustly and without causing damage to the blade. Deactivation is intended to be representative of loosening or releasing the handling assembly from the blade, e.g. for removal of a blade. Preactivation is intended to refer to processes of preparing or enhancing the protective and/or gripping action of the cushion on the blade, frame, or both. Preactivation may occur before or after activation, but preferably before activities such as transporting the blade held by the assembly with the blade, lifting the blade that is held by the handling assembly, moving the blade held by the handling assembly, and the like.

For example, a process of transporting a blade may be by: placing the blade in a handling assembly, optionally preactivating the handling assembly to protect or enhance the protection of the blade, activating the handling assembly to hold the blade, transporting the handling assembly and blade, deactivating the handling assembly to release the blade, and removing the blade from the handling assembly. The handling assembly aids, alternatively or additionally to the transport of blades, many other activities associated with the handling of wind turbine blades, for example storing and lifting.

In an embodiment, an influx of fluid into the expandable cushion causes the cushion to expand to fill at least part of the space between the section of the blade within the frame and the inside of the frame. For example, the cushion is activated by an influx of fluid into the cushion which causes the cushion to expand and adapt to the shape of at least part of the space between the blade and the inside of the frame. In other words, the expandable cushion is cast to the profile of at least a portion of a section of the wind turbine blade (e.g. a section of the blade partially or completely surrounded by the frame) by the influx of fluid. The blade is firmly but gently held by the handling assembly. The influx of fluid (e.g. through a port) into the cushion, and optionally the resulting pressurization of the cushion activates the handling assembly. The influx of fluid may be forced by the action of at least one pump or compressor. An activated cushion may be sealed by closing the port or the activated cushion may remain connected to a pump or compressor. A pressure-activated switch may maintain a fairly constant pressure in the cushion.

A precise and robust enclosure is required to safely handle blades, yet the blade surfaces are sensitive to forces applied to them. An activated cushion holds the blade firmly, with optimal load distribution over the surface of the blade. The activated cushion can ensure safe transport of the blade. An advantage of the handling assembly is that it is self-adapting to the actual geometry of the blade at the contacted position or positions. This enables optimal pressure distribution over the surface, provides a safe grip, and/or compensates for shape variations.

The cushion may be deactivated by the outflux of fluid from the cushion, which enables the separation of the handling assembly from the blade (and/or the removal, release, or loosening of the blade from the handling assembly). The outflux of fluid out of the cushion may be induced by opening the port, puncturing the cushion, or applying a negative relative pressure across the port (i.e. applying a relative vacuum). Outflux may be induced by opening a valve of the port or to the port.

FIG. 4 shows a cross-section of a handling assembly 150 with a port 120, according to embodiments. The handling assembly comprises a frame 160 adapted to surround a section of the blade 22, and an expandable cushion 190. A port 120 accommodates the influx of a fluid into the cushion, the outflux of fluid from the cushion, or both. The port may connect to one or more chambers of the cushion, and it may be connected on the other side to one or more pumps, compressors, air compressors, or vacuums. Moreover, the port may contain a valve, multiple valves, and/or seals.

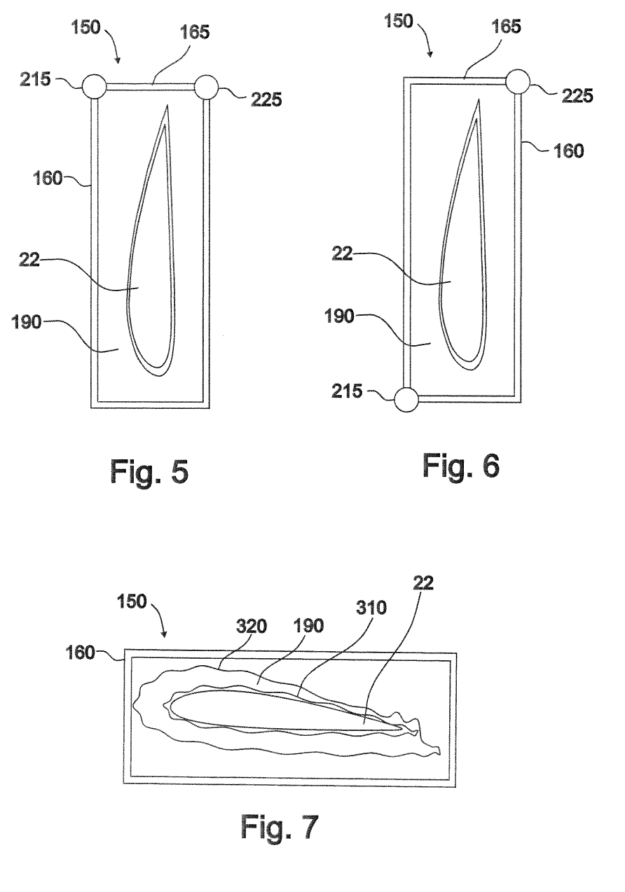

FIG. 5 shows a cross-section of a handling assembly 150 with a movable lid 165, according to embodiments. The movable lid 165 may be regarded as part of the frame 160, or as separable from the frame 160. The movable lid 165 has a first lid attachment 215 and a second lid attachment 225, where the movable lid 165 attaches to the frame 160. More or fewer than two lid attachments 215, 225 are contemplated, such as 1, 3, or 4 or more (e.g. 8 or 10). The movable lid may be hinged to swing open (e.g. at least one of the lid attachments is a hinge), or may be entirely removed from the frame (e.g. the lid attachments are bolts or the like). The movable lid allows the blade to be inserted and/or removed from the handling assembly. The movable lid 165 may be oriented along the short axis of the blade, as shown in FIG. 5, or the width of the blade, or a combination thereof.

FIG. 6 shows a cross-section of a handling assembly 150 with a movable lid 165 and two lid attachments 215, 225, according to embodiments. The movable lid is shaped so that when the lid is opened, the blade 22 can be removed easily. FIG. 6 shows the first lid attachment 215 and the second lid attachment 225 on opposite corners of the frame 160, according to an embodiment. An advantage is that upon opening (e.g. removal) of the movable lid 165, the frame 160 is exposed so that the blade 22 is easily inserted or removed.

FIG. 7 shows a handling assembly 150 comprising a frame 160, and an expandable cushion 190 comprising an inner membrane 310 and outer membrane 320, according to an embodiment. The expandable cushion 190 is adapted to at least partially surround a section of the blade 22, as is the frame 160. The inner membrane 310 and outer membrane 320 may be connected, thus a continuous surface defines the surface of the expandable cushion 190.

In an embodiment, soft packing particles, fluid, or a combination thereof are disposed within the expandable cushion 190. For example, soft packing particles such as starch-based packing particles, polystyrene fill, polystyrene balls, or polystyrene peanuts are used. In an embodiment, the fluid is a gas such as air.

An influx of fluid into the expandable cushion 190, for example upon activation, causes the cushion to expand. Thus, toward the inside of the handling assembly, the expandable cushion 190 conforms to the shape of a section of the blade surrounded by the frame. In other words, the cushion is adapted to be cast to the profile of at least a portion of a section of the wind turbine blade by the influx of the fluid. The blade is held by the expanded (or activated) expandable cushion 190, which may be under pressure of fluid; and, toward the outside, the expandable cushion 190 conforms to at least part of the inner wall of the frame. The expanded cushion 190 holds the wind turbine blade 22.

In deactivating the handling assembly, the expandable cushion 190 can be unexpanded or depressurized by the outflux of fluid from the expandable cushion 190; and the blade is loosened or released from the grip of the handling assembly.

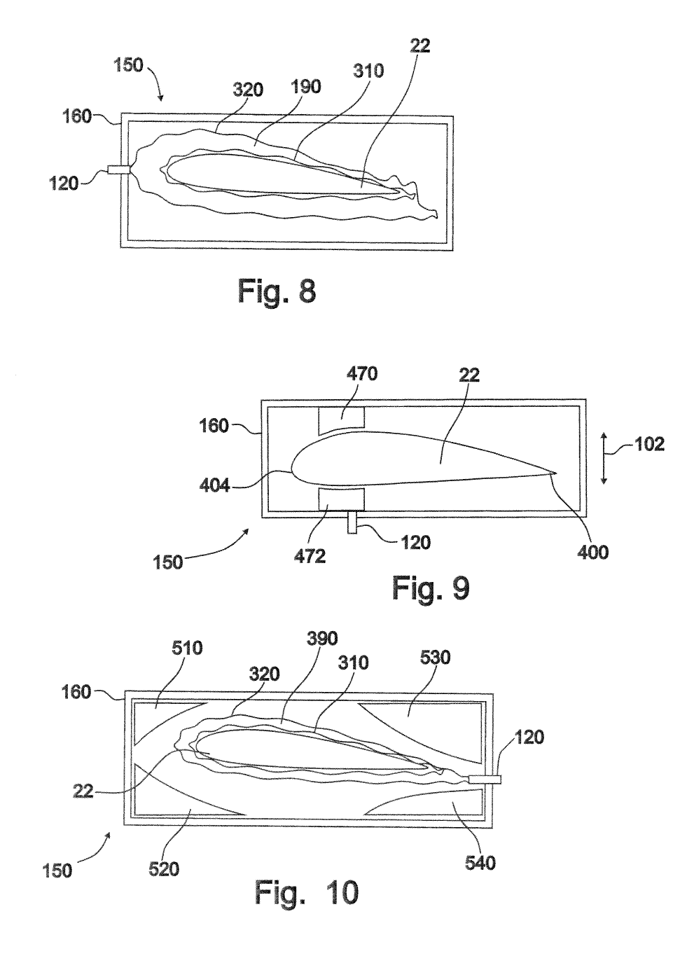

FIG. 8 shows a handling assembly 150 comprising a frame 160, an expandable cushion with an inner membrane 310 and outer membrane 320, and a port 120, according to an embodiment. The port accommodates at least one of: the influx of the fluid into the cushion, and an outflux of the fluid from the cushion. The port may extend outward from the inside of the frame in any direction, or may lie within the frame. Access to the port may be provided by a hole in the frame. The port may comprise a valve.

FIG. 9 shows an expandable cushion of two chambers 470, 472, located on opposite sides of the inside of the frame 160, according to an embodiment. Thus, the two chambers 470, 472 are configured to lie, when the blade 22 is inserted, along the short axis 102 of the blade, according to an embodiment. Expansion of at least one of the two parts 470, 472 of the cushion may activate the handling assembly, robustly holding the blade within the handling assembly, and preventing damage to the blade during handling. A cushion with more than two chambers is also contemplated, for example a cushion with a third chamber located at the leading edge 404 of the blade is contemplated (not shown). In yet another example, a fourth chamber of the cushion is located at the trailing edge 400 of the blade 22. Each chamber of the cushion may be expandable, or only 1, 2, 3, or 4 chambers of the cushion may be expandable. A port 120 is connected either directly, or through a tube or hose, to any number (e.g. 1, 2, 3, or 4) of chambers that are to be expanded, unexpanded, or compressed, or a combination thereof.

FIG. 10 shows a handling assembly with an expandable cushion that comprises internal fixations 510, 520, 530, 540 in the corners of the frame, according to an embodiment. The internal fixations provide cushioning in the corners of the frame. The internal fixations may be hoses, foam, chambers, expandable chambers, or the like. The cushion also optionally comprises a chamber 390 (e.g. a hose or pillow) with an inner membrane 310 and outer membrane 320, which is expandable. The chamber 390 may surround at least part of a section of the blade. An optional port 120 allows the influx and/or outflux of fluid (e.g. gas or air) into or out of the chamber. The chamber may optionally contain soft packing particles, for example polystyrene particles, fill, balls, or peanuts. The internal fixations increase the cushioning effect of the cushion and increase the stability of the blade in the handling assembly, preventing damage to the blade during handling. Internal fixations may alternatively or additionally be placed on the sides of the frame, or the periphery of the inside of the frame.

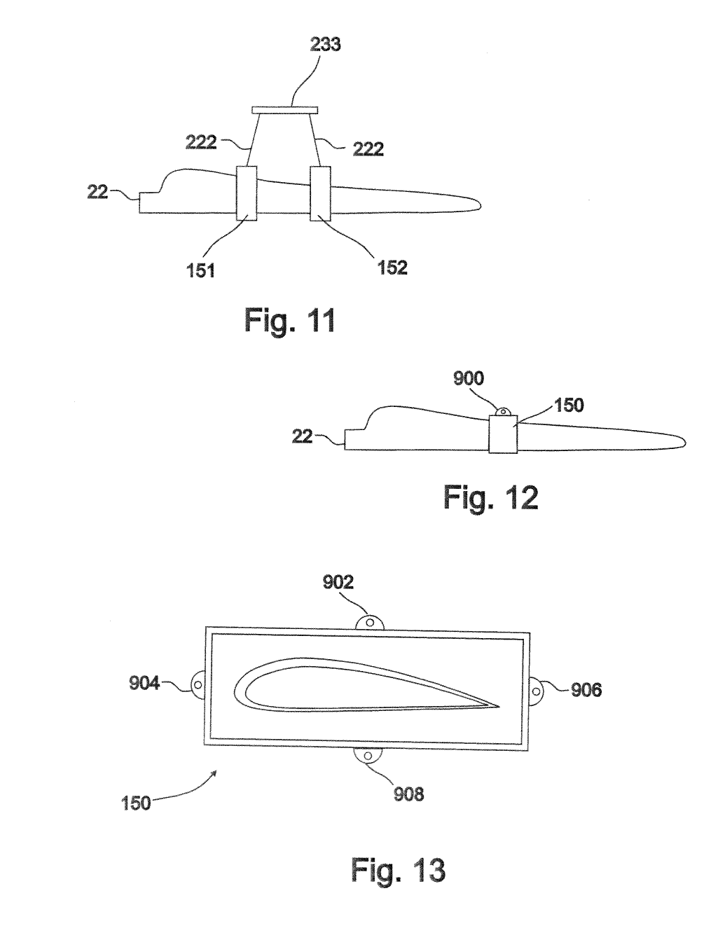

In FIG. 11, the handling assembly has two parts 151, 152 that surround two sections of the blade 22, according to an embodiment. A cable 222 connects the parts 151, 152 of the handling assembly to a beam 233 for lifting. A handling assembly of multiple parts, such as the two parts in the embodiment shown in FIG. 11, is a general feature that may be combined with any embodiment. A handling assembly of multiple parts is advantageous particularly but not exclusively in erection, e.g. construction, of a wind turbine, and more particularly for attaching wind turbine blades 22 to a hub, because of the increased stability of handling the blade at two separate regions in comparison to handling only one region of the blade.

FIG. 12 shows a handling assembly 150 with an attachment point 900, such as a flange with a hole, attached the frame (e.g. the outside of the frame), according to an embodiment. The attachment point facilitates attachment of connecting hardware (for example cables, hooks, linkages, bolts, chains, or other means for attaching, securing, and/or lifting the handling assembly) for securing or handling the handling assembly. FIG. 13 shows a handling assembly with four attachment points 902, 904, 906, 908, according to an embodiment. A number of attachment points are contemplated, for example, 1, 2, 3, 4 or even more such as 8 attachment points. An advantage to multiple attachment points is to increase the ease with which the handled and/or secured blade can be oriented. For example, in some situations it may be advantageous to lift the blade so that the short axis is perpendicular to the ground; whereas in other situations, it may be more advantageous to lift the blade so that the width is perpendicular to the ground. Attachment points, which can be attached to the frame and adapted to attach to cables, hooks, connectors, or mounts and the like, may be combined with any embodiment. Attachment points may alternatively or additionally be holes in the frame such as to accommodate pegs of connecting hardware. Alternatively or additionally, they may be threaded holes to accommodate bolts.

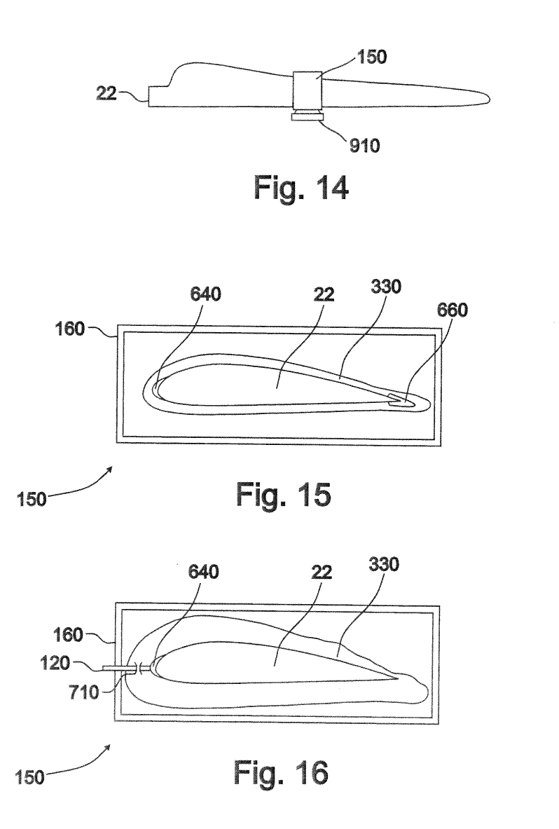

FIG. 14 shows a handling assembly 150 with a platform 910, according to an embodiment, adapted for handling a blade 22. The platform provides stability for the handling assembly when it rests on a surface, such as for example the bed of a truck, or a trailer, or the ground. A handling assembly with two parts, similar to that shown in FIG. 10, and with each part having a platform 910 as shown in FIG. 13 is also envisioned. The platform 910 may be combined with any embodiment. For example, attachment points as described above may be placed on or in the platform. Alternatively of additionally, a handing assembly with attachment points attached to the frame may also have a platform, which may have additional attachment points. For example, the top of the frame has a flange with a hole, and the platform has pegs or threaded or unthreaded holes.

FIG. 15 shows a handling assembly 150 with a frame 160, according to an embodiment. The expandable cushion comprises a leading edge chamber 640 and a trailing edge chamber 660 (both are regarded as examples of “inner chambers”), which are adapted to be cast to the shape of the leading and trailing edges of the blade 22. Soft packing particles are disposed within the inner chambers 640, 660. The expandable cushion is preactivated, i.e. the inner chambers 640, 660 are cast to the profile of at least a portion of the section of the blade. Casting is accomplished by, for example, the outflux of fluid from the inner chambers 640, 660. The inner chambers are disposed toward the center of the frame in comparison to an optional outer chamber 330 or internal fixations that, one of which at least, at least partially surrounds the inner chambers.

In an embodiment, one or more inner chambers compress due to the outflux of fluid from them, causing the one or more inner chambers 640, 660 to be cast to the profile of at least a portion of the blade, e.g. the leading and/or trailing edges. An advantage is that by casting one or more inner chambers 640, 660, the leading and/or trailing edges of the blade 22 are especially well protected from damage during handling.

Alternatively or additionally, preactivation is by the outflux of fluid from the leading and trailing edge cushion portions 640, 660 by the action of a vacuum, pump, or compressor. Following preactivation, the expandable cushion can be activated by expanding (e.g. inflating) the outer chamber 330 by the influx of fluid so that the outer chamber 330 expands to take up at least part of the space between the section of the blade surrounded by the frame and the frame, thus holding the blade. Therefore, a chamber may be compressed or deflated by the outflux of a fluid, for example to cast particles lying within the chamber; or expanded or inflated by an influx of fluid to hold the blade.

In an embodiment, an inner chamber is disposed toward the center of the frame from an outer chamber of the expandable cushion. Thus the inner chamber is adapted to be cast to the profile of at least a portion of the wind turbine blade (e.g. the portion of the section of the blade surrounded by the frame). For example, the inner chamber is cast around the blade 22 by a vacuum applied to the inner chamber. The outer chamber is subsequently expanded (e.g. inflated) to hold the blade.

Alternatively or additionally, a one inner chamber that is adapted to surround a portion of the blade 22, has soft packing particles disposed therein. After insertion of the blade, the one inner chamber may be preactivated by the outflux of fluid from the one inner chamber. Preactivation causes the particles to be cast to the profile or shape of the blade, which increases the cushioning of the blade, e.g. near at least one of the leading and trailing edges.

Other inner chambers are contemplated, additionally or alternatively to the leading and trailing edge chambers 640, 660. Other inner chambers may be “preactivated,” cast, or compressed, for example by the outflux of air from the inner chambers. One, two, three, four, or more inner chambers may be cast to the profile of at least a portion of the section of the blade. For example, a number (1, 2, 3, or 4, for example) of inner chambers with soft packing particles disposed therein may be cast to at least one of: the profile of at least a portion of the section of the blade surrounded by the frame, and at least a portion of the inside of the frame. Casting may be followed by expansion of an outer chamber, to hold the blade, and filling at least part of the space between the blade and the frame.

In yet another embodiment, soft packing particles (for example polystyrene particles) disposed within an inner chamber may be cast to the shape of at least a portion of the blade by the removal of a fluid such as gas, or more specifically air, from the inner chamber. An outer chamber, which is adapted to surround at least part of the blade, may be used to further cushion the blade and the cast the inner chamber. The outer chamber may also be expanded and/or pressurized to hold the blade.

FIG. 16 (corresponding to FIG. 7 page 2/3 from the inventor) of shows a handling assembly 150, according to an embodiment. The handling assembly comprises a frame 160 and expandable cushion comprising a chamber 330 that are adapted to surround a portion of the blade 22. A leading edge chamber 640 is connected to a port 120. A fluid permeable connection 710 exists between two halves of the chamber 330.

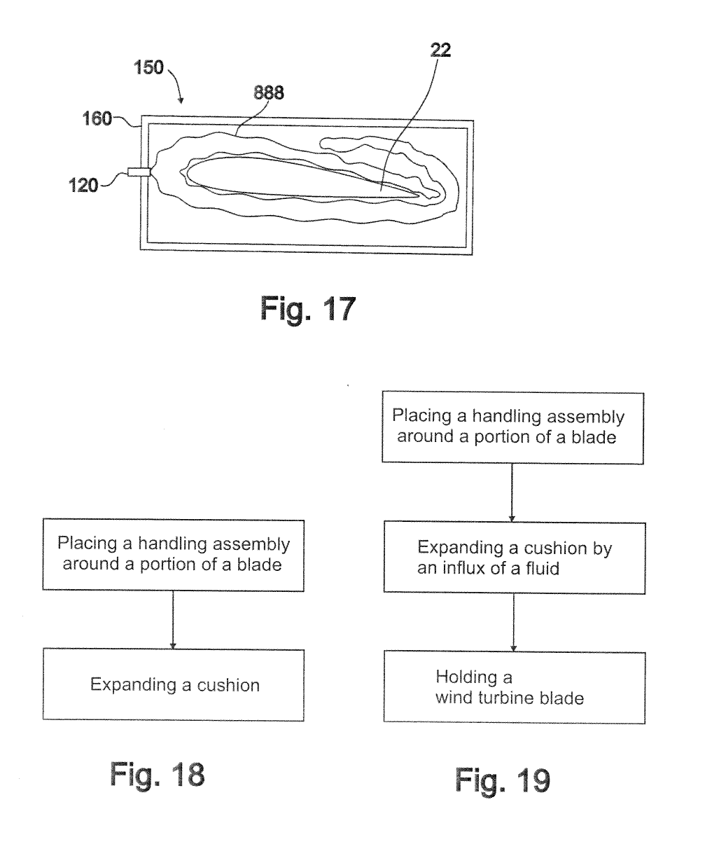

FIG. 17 shows a cross-section of a handling assembly 150 according to an embodiment. The handling assembly comprises a frame 160 adapted to surround a section of the blade, an expandable cushion comprising a chamber 888, and a port 120. The two openings of the frame are parallel with the page of FIG. 16. The chamber 888 is adapted to wrap at least partially around the blade, which provides the advantage of allowing the blade to be easily placed in the handling assembly, especially when combined with an embodiment that includes a movable lid. Upon activation, an influx of fluid into the chamber 888 causes it to expand to hold the blade 22 within the frame 160.

FIG. 18 shows, according to an embodiment, a flowchart that describes a method of handling a wind turbine, comprising: placing a handling assembly around a portion of a blade, and expanding a cushion between the handling assembly and the blade. FIG. 19 shows, according to an embodiment, a flowchart describing a method of handling a wind turbine blade comprising: placing a handling assembly around a portion of a blade, expanding a cushion by an influx of a fluid, and holding a blade with an expanded cushion. The embodiments illustrated by FIGS. 18 and 19 may also each optionally comprise steps of: deflating or deactivating the cushion to release the blade, preactivating the cushion to cast the cushion around at least part of the wind turbine blade, and/or attaching a connecting hardware to an attachment point of the handling assembly.

Exemplary embodiments of systems and methods for handling wind turbine blades are described above in detail. The systems and methods are not limited to the specific embodiments described herein, but rather, components of the systems and/or steps of the methods may be utilized independently and separately from other components and/or steps described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose embodiments, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A handling assembly for a wind turbine blade, comprising:
a frame adapted to at least partially surround a section of the wind turbine blade,
an expandable cushion adapted to fill at least part of the space between the section of the wind turbine blade and the frame.

2. The handling assembly of claim 1, wherein
the expandable cushion is adapted to be expanded by an influx of a fluid into the cushion.

3. The handling assembly of claim 2, wherein
the expandable cushion is expanded to hold the wind turbine blade; and, wherein
the expandable cushion is unexpanded otherwise.

4. The handling assembly of claim 3, wherein
the fluid is air.

5. The handling assembly of claim 3, wherein
the cushion is adapted to be cast to the profile of at least a portion of the section of the wind turbine blade by the influx of the fluid.

6. The handling assembly of claim 1, wherein
the frame further comprises a movable lid for accommodating at least one of the insertion and removal of the wind turbine blade from the handling assembly.

7. The handling assembly of claim 3, further comprising
a port to accommodate at least one of: the influx of the fluid into the cushion,
and an outflux of the fluid from the cushion.

8. The handling assembly of claim 3, wherein
the cushion further comprises a first chamber.

9. The handling assembly of claim 8, wherein
the expandable cushion further comprises a second chamber.

10. The handling assembly of claim 9, wherein
the first chamber and the second chamber are positioned on opposite sides of the inside of the frame.

11. The handling assembly of claim 8, wherein
the expandable cushion further comprises soft packing particles disposed within the first chamber.

12. The handling assembly of claim 11, wherein
the first chamber is adapted to be cast to the profile of at least a portion of the section of the wind turbine blade surrounded by the frame by the outflux of the fluid from the cushion.

13. The handling assembly of claim 1, further comprising
an attachment point for connecting hardware to the handling assembly for securing or handling the handling assembly.

14. The handling assembly of claim 1, further comprising
internal fixations to provide cushioning in the periphery of the inside of the frame.

15. The handling assembly of claim 1, further comprising
a platform to provide stability for the handling assembly when the handling assembly rests upon a surface.

16. A handling assembly for a wind turbine blade, comprising:
a frame adapted to at least partially surround a section of the wind turbine blade,
an inflatable cushion, and
a port; wherein
the frame comprises openings adapted to allow the wind turbine blade to be positioned through the frame; and, wherein,
the inflatable cushion comprises a chamber; and, wherein,
the port is connected to the chamber to allow at least one of: an influx and an outflux of a fluid; and, wherein,
the influx of the fluid is associated with expansion of the cushion and casting of the cushion to at least a portion of the surface of the wind turbine blade.

17. A method of handling a wind turbine blade, comprising:
placing a handling assembly around a portion of the wind turbine blade, and
expanding an expandable cushion between the handling assembly and the wind turbine blade to hold the wind turbine blade.

18. The method of handling a wind turbine blade of claim 17, further comprising:
deactivating the cushion to release the wind turbine blade.

19. The method of handling a wind turbine blade of claim 18, further comprising:
preactivating the cushion to cast the cushion around at least part of the wind turbine blade.

20. The method of handling a wind turbine blade of claim 18, further comprising:
attaching a connecting hardware to an attachment point of the handling assembly.
